(19) United States
(12) Patent Application Publication
(10) Pub. No.: US 2021/0141771 A1
(43) Pub. Date: May 13, 2021

(54) METHOD OF MANAGING FILES BY MOBILE DEVICE AND MOBILE DEVICE FOR IMPLEMENTING THE SAME

(71) Applicant: SAMSUNG ELECTRONICS CO., LTD., Suwon-si (KR)

(72) Inventors: Yi LIANG, Guangzhou (CN); Haifeng YANG, Guangzhou (CN); Yingjue TIAN, Guangzhou (CN)

(73) Assignee: SAMSUNG ELECTRONICS CO., LTD., Suwon-si (KR)

(21) Appl. No.: 17/095,322

(22) Filed: Nov. 11, 2020

(30) Foreign Application Priority Data
Nov. 12, 2019 (CN) 201911099147.X
Sep. 29, 2020 (KR) 10-2020-0127392

(51) Int. Cl. G06F 16/188; G06F 16/13; G06F 16/16

(52) U.S. Cl. CPC G06F 16/192; G06F 16/168; G06F 16/13

(57) ABSTRACT

A method of managing files by a mobile device includes generating virtual directory information corresponding to files stored in the mobile device; and transmitting the generated virtual directory information to an external device. In response to the virtual directory information being received by the external device, a virtual directory included in the virtual directory information is displayed on the external device, and the files stored in the mobile device are accessible through the displayed virtual directory.

### CROSS-REFERENCE TO RELATED APPLICATIONS

This application is based on and claims priority under 35 U.S.C. § 119 to Chinese Patent Application No. 201911099147.X, filed on Nov. 12, 2019, in the State Intellectual Property Office (SIPO) of the People's Republic of China and Korean Patent Application No. 10-2020-0127392, filed on Sep. 29, 2020, in the Korean Intellectual Property Office, the disclosures of which are incorporated by reference herein in their entireties.

### BACKGROUND

### 1. Field

The disclosure relates to a mobile device, and more specifically, to a method of managing files by a mobile device such that an external device may easily access the files stored in the mobile device, and the mobile device using the method.

### 2. Description of Related Art

With the development of electronic technologies and various mobile devices, users store more files in the mobile devices.

As the number of stored files increases, users may feel inconvenience in managing mobile devices. In general, when a user connects a mobile device to a computer, the mobile device may transmit, to the computer, actual directory information generated according to actual storage paths of files, and the user may access the files stored in the mobile device through the computer based on the received directory information.

Additionally, as the number of files stored in the mobile device increases, it is difficult for the user to remember which storage path a specific file is stored in, and thus it takes a lot of time to search for the specific file.

### SUMMARY

Provided is a method of managing files by a mobile device such that an external device may easily access the files stored in the mobile device, and the mobile device using the method.

Additional aspects will be set forth in part in the description which follows and, in part, will be apparent from the description, or may be learned by practice of the presented embodiments of the disclosure.

According to an aspect of the disclosure, a method of managing files by a mobile device including: generating virtual directory information corresponding to files stored in the mobile device; and transmitting, to an external device, the generated virtual directory information to cause the external device to display a virtual directory included in the virtual directory information and through which the files stored in the mobile device are accessible through the displayed virtual directory.

The virtual directory may be generated by grouping the files stored in the mobile device in a predefined manner such that files of a same group are in a same subdirectory.

The predefined manner may be different from a manner of grouping the files based on storage paths of the files in a storage space of the mobile device, and may not modify the storage paths of the files in the storage space of the mobile device.

The virtual directory information may include virtual drive letter information. The transmitting, to the external device, the generated virtual directory information causes the external device to display a virtual drive letter and the virtual directory under the virtual drive letter. The virtual drive letter may be different from an actual drive letter indicating a storage space of the mobile device.

The predefined manner may include at least one of a manner of grouping the files based on file directories displayed to a user by the mobile device, a manner of grouping the files based on media types of the files, a manner of grouping the files based on modification dates of the files, a manner of grouping the files based on creation dates of the files, a manner of grouping the files based on applications to which the files belong, a manner of grouping the files based on sources of the files, or a manner of grouping the files based on privacy levels of the files.

The method may further include providing a user interface configured to receive a selection of at least one file category to be included in the virtual directory. The virtual directory information may be generated based on the at least one file category selected through the user interface.

The method may further include updating the virtual directory information, in response to modification of the files stored in the mobile device; and transmitting, based on the virtual directory information being updated after the virtual directory information is transmitted to the external device, the updated virtual directory information to the external device.

The method may further include transmitting a directory of a storage space of the mobile device to the external device such that the external device displays the virtual directory and the directory of the storage space of the mobile device.

The mobile device may transmit the virtual directory information to the external device using a predefined software protocol for media file transfer.

According to another aspect of the disclosure, a mobile device may include a memory configured to store at least one instruction; and a processor configured to execute the at least one instruction to generate virtual directory information corresponding to files stored in the mobile device, and transmit, to an external device, the generated virtual directory information to cause the external device to display a virtual directory included in the virtual directory information and through which the files stored in the mobile device are accessible through the displayed virtual directory.

The virtual directory may be generated by grouping the files stored in the mobile device in a predefined manner such that files of a same group are included in a same subdirectory.

The predefined manner may be different from a manner of grouping the files based on storage paths of the files in a storage space of the mobile device, and does not modify the storage paths of the files in the storage space of the mobile device.

The virtual directory information may include virtual drive letter information. The processor may be further configured to execute the at least one instruction to transmit, to the external device, the generated virtual directory information to cause a virtual drive letter to be displayed on the external device and the virtual directory to be displayed under the virtual drive letter. The virtual drive letter may be different from an actual drive letter indicating a storage space of the mobile device.

The predefined manner may include at least one of a manner of grouping the files based on file directories displayed to a user by the mobile device, a manner of grouping the files based on media types of the files, a manner of grouping the files based on modification dates of the files, a manner of grouping the files based on creation dates of the files, a manner of grouping the files based on applications to which the files belong, a manner of grouping the files based on sources of the files, or a manner of grouping the files based on privacy levels of the files.

The processor may be further configured to execute the at least one instruction to provide a user with a user interface configured to receive a selection of at least one file category to be included in the virtual directory. The virtual directory information may be generated based on the at least one file category selected through the user interface.

The processor may be further configured to execute the at least one instruction to update the virtual directory information, in response to modification of the files stored in the mobile device, and transmit, based on the virtual directory information being updated after the virtual directory information is transmitted to the external device, the updated virtual directory information to the external device.

The processor may be further configured to execute the at least one instruction to transmit a directory of a storage space of the mobile device to the external device such that the external device displays the virtual directory and the directory of the storage space of the mobile device.

The virtual directory information may be transmitted to the external device using a predefined software protocol for media file transfer.

According to another aspect of the disclosure, a non-transitory computer-readable recording medium having recorded thereon a program which is executed by a processor to perform the method.

### BRIEF DESCRIPTION OF THE DRAWINGS

The above and other aspects, features, and advances of certain embodiments of the present disclosure will be more apparent from the following description taken in conjunction with the accompanying drawings, in which:

FIG. 1 is a block diagram of a mobile device according to an embodiment;

FIG. 2 is a flowchart of a method of managing files by a mobile device according to an embodiment;

FIG. 3 is a flowchart of a method of managing files by a mobile device according to another embodiment;

FIG. 4 is a diagram of a process of displaying an actual directory and a virtual directory of a mobile device on an external device according to an embodiment;

FIG. 5 is a diagram of a process of generating a virtual directory through a file rasterizer according to an embodiment;

FIG. 6 is a flowchart of a method of updating a virtual directory by a mobile device according to an embodiment;

FIG. 7 is a diagram of an external device accessing files stored in a mobile device through a virtual directory generated according to an embodiment;

FIG. 8 is a diagram of a user interface through which a user selects a group of the virtual directories according to an embodiment; and

FIG. 9 is a flowchart of a method of managing files by a mobile device according to an embodiment.

### DETAILED DESCRIPTION

Features of the disclosure, and methods for accomplishing the same will become apparent with reference to the following embodiments and the accompanying drawings. However, the disclosure is not limited to the embodiments described below, but may be implemented in various forms different from each other, and the present embodiments are provided to inform those of skill in the art to which the disclosure belongs, of the scope of the disclosure and are defined only by the scope of the claims.

The terms used in this specification are selected from currently widely used general terms in consideration of functions of the disclosure, but may vary according to the intentions or practices of those skilled in the art or the advent of new technology. In addition, terms arbitrarily selected by the applicant are used in specific case, and in this case, its meaning will be described in the corresponding description of the disclosure. Accordingly, the terms used in this specification should be interpreted on the basis of substantial implications that the terms have and the contents across this specification not the simple names of the terms.

Throughout the disclosure, the expression “at least one of a, b or c” indicates only a, only b, only c, both a and b, both a and c, both b and c, all of a, b, and c, or variations thereof.

Throughout the specification, when a portion may “include” or “comprise” a certain element, unless specified otherwise, it may not be construed to exclude another element but may be construed to further include other elements.

Throughout the specification, the term ‘virtual directory’ may refer to a logical directory generated by linking to an actual storage path so as to facilitate access to files existing in the actual storage path.

For example, when a storage path in which a file is actually stored is ‘D:\WebService\download\DIM\audio’, the virtual directory may be generated as ‘D:\Music’. In this case, although the virtual directory such as ‘D:\Music’ is not a directory existing on the actual storage, when the user accesses the virtual directory, the user may access the actual directory logically linked to the corresponding virtual directory.

In the disclosure, even if an operation of allowing, by the mobile device, the external device to access the mobile device is not explicitly described, it may be conditioned upon the mobile device confirming whether the external device has a right to access the files stored in the mobile device and has permitted the external device to access.

Hereinafter, example embodiments will be described in detail with reference to the accompanying drawings so as to be easily realized by those of skill in the art. In the accompanying drawings, portions unrelated to the description are omitted in order to clearly illustrate the disclosure.

FIG. 1 is a block diagram of a mobile device according to an embodiment.

A mobile device 100 may be a communication terminal such as a smart phone, a smart wearable device such as a smart watch, a tablet computer, a game machine, a digital multimedia player, or various other types of mobile devices 100.

The mobile device 100 may be an electronic terminal capable of storing various files such as a user's personal files, multimedia files, and the like.

The mobile device 100 may include a memory 110 and a processor 120.

The memory 110 may store a program to be executed by the processor 120, which will be described later, to control an operation of the mobile device 100. For example, the memory 110 may store at least one instruction that may be read and executed by the processor 120, such that the processor 120 may execute operations of FIG. 2, included in the method of managing files, which will be described later.

According to an embodiment, the at least one instruction may include instructions for executing an operation of generating virtual directory information on files stored in the mobile device 100 and transmitting the generated virtual directory information to an external device.

The virtual directory information on the files stored in the mobile device 100 may refer to information on a virtual directory linked to a directory in which the files are actually stored in the mobile device 100.

The virtual directory may have a name that is simpler than that of the actual directory or that is intuitively and more easily recognized. The virtual directory may have a structure that is simpler than that of the actual directory or that is intuitively and more easily recognized.

The generation of the virtual directory information will be described later in more detail with reference to FIGS. 4 and 5.

According to an embodiment, the external device may be an electronic device to be connected to the mobile device 100 in various manners and to access the files stored in the mobile device 100.

The virtual directory included in the virtual directory information, when received by the external device, may be displayed on the external device without additional program installation or configuration changes. According to an embodiment, the virtual directory, when received by the external device, may be displayed on the external device, instead of the actual directory.

The files stored in the mobile device 100 may be directly accessed by the external electronic device through the virtual directory without information on the storage path in which the files are actually stored.

In the disclosure, the term ‘access’ may refer to all operations of reading, modifying, or deleting a file.

According to an embodiment, the mobile device 100 may include a plurality of memories.

The processor 120 may execute the instruction stored in the memory 110.

Although the memory 110 and the processor 120 are illustrated as separate components in the present embodiment, according to other embodiments, the memory 110 and the processor 120 may be combined and implemented as a single component.

In addition, although the memory 110 and the processor 120 are illustrated as being adjacent to each other in the mobile device 100 in the present embodiment, the memory 110 and the processor 120 may be distributed according to other embodiments, because devices that perform respective functions of the memory 110 and the processor 120 are not necessarily physically adjacent to each other.

Furthermore, because the mobile device 100 is not limited to a physical device, some functions of the mobile device 100 may be implemented as software rather than hardware.

According to some embodiments, the mobile device 100 may further include an output unit, a communication interface, and the like.

Each of the elements described in the specification may be composed of one or more components, and the names of the elements may vary according to the type of the mobile device 100. In various embodiments, the mobile device 100 may include at least one of the elements described herein, and some elements may be omitted or additional other elements may be further included. In addition, some of the elements of the device 100 according to various embodiments may be combined into one entity, and thus the functions of the original elements before the combination may be performed in the same manner.

According to another embodiment, the mobile device 100 may include separate hardware units. In this embodiment, each hardware unit may be responsible for each operation or sub-operation of the disclosed method.

FIG. 2 is a flowchart of a method of managing files by a mobile device 100 according to an embodiment.

In operation S210, the mobile device 100 may generate virtual directory information on the files stored in the mobile device 100. The virtual directory information may be used to display a corresponding virtual directory.

The virtual directory may have a logical directory structure generated by reconstruction such that the external device may access the files stored in the mobile device 100, and the generation of the virtual directory does not affect locations in which the actual files are stored.

The mobile device 100 may generate the virtual directory information on all or some of the files stored in the mobile device 100.

According to an embodiment, the mobile device 100 may generate the virtual directory information only for files designated by the user.

The files stored in the mobile device 100 may include all files stored in an internal storage device of the mobile device 100 and files stored in an external storage device of the mobile device 100.

According to an embodiment, the virtual directory may include subdirectories of various levels, and the subdirectory may be generated by grouping the corresponding subdirectories into a group.

The virtual directory information may further include virtual drive letter information. The virtual drive letter information may be information on a name or an alias indicating the virtual drive.

The virtual directory information of the mobile device 100 may be transmitted to the external device in a predefined manner, and the external device may receive the virtual directory information in a predefined manner, and then may display the virtual drive letter included in the virtual drive letter information through a file management program of an operating system.

The virtual directory of the mobile device 100 may be displayed together with the virtual drive letter through the file management program of the operating system installed in the external device. The virtual drive letter may be different from an actual drive letter used to indicate an actual storage space of the mobile device 100.

The external device may automatically display the virtual drive letter or the virtual directory upon receipt of the virtual drive letter or the virtual directory from the mobile device 100 without an additional operation such as installing an additional application, changing a configuration of the external device, or changing a received file, for displaying the virtual drive letter or the virtual directory received from the mobile device 100.

In operation S220, the virtual directory information may be transmitted to the external device in the predefined manner.

The predefined manner may be a manner of using a predefined software protocol for media file transfer.

According to an embodiment, the predefined software protocol for media file transfer may be a media transfer protocol (MTP).

The external device may receive the virtual directory information in the predefined manner, and then display the virtual directory included in the virtual directory information through the file management system of the operating system.

The external device may display the virtual directory in response to receiving the virtual directory information from the mobile device 100 without an additional operation such as installing an additional application for displaying the virtual directory of the mobile device 100.

The files stored in the mobile device 100 may be accessed via the virtual directory displayed on the external device.

Specifically, the user may search for a desired file by exploring the virtual directory displayed on the external device, and may access the corresponding file stored in the mobile device by clicking a file in a search result. This will be described in detail later with reference to FIG. 7.

According to an embodiment, in a case where the external device is a Windows platform-based computer device, the external device may receive the virtual directory information in the predefined manner, and then may immediately display the virtual directory included in the virtual directory information through a file resource manager of the operating system.

According to another embodiment, in a case where the external device is an Apple system platform-based computer device such as macOS, the external device may receive the virtual directory information in the predefined manner and then may display the virtual directory included in the virtual directory information through a file manager of the operating system.

The method of managing files of the mobile device 100 according to another embodiment may include determining whether to provide the actual directory of the mobile device 100 to the external device according to the user's selection.

The method of managing files of the mobile device 100 may further include providing the actual directory of the mobile device 100 to the external device in a predefined manner such that the external device may display both the virtual directory and the actual directory.

FIG. 3 is a flowchart of a method of managing files by a mobile device according to another embodiment.

In operation S310, the mobile device 100 may establish a connection with the external device.

The external device may be a device configured to access the files in the mobile device 100 after the connection with the mobile device 100 is established, and perform manipulation such as displaying and copying.

For example, the external device may be any one electronic device, which is capable of communication, of mobile devices such as smart phones, laptops, and smart pads, and wired devices such as desktop PCs, smart TVs, and various home appliances.

According to an embodiment, the mobile device 100 and the external device may be based on different operating system platforms. That is, the operating system platform of the external device may be different from the operating system platform of the mobile device 100.

For example, the mobile device 100 may be based on an embedded operating system platform, and the external device may be based on a Windows platform. The embedded operating system platform may include an IOS platform or an Android platform.

The mobile device 100 may establish the connection with the external device in a wired or wireless manner.

For example, the wireless manner may use, for example, as a cellular communication protocol, at least one of long-term evolution (LTE), LTE Advance (LTE-A), code division multiple access (CDMA), wideband CDMA (WCDMA), universal mobile telecommunications system (UMTS), wireless broadband (WiBro), or global system for mobile communications (GSM). The wireless manner may include, for example, short-range communication. The short-range communication may include, for example, at least one of wireless fidelity (Wi-Fi), Bluetooth, near field communication (NFC), or global navigation satellite system (GNSS), but is not limited thereto. The GNSS may include, for example, at least one of a global positioning system (GPS), a global navigation satellite system (Glonass), Beidou Navigation Satellite System (hereinafter, referred to as ‘Beidou’), Galileo, or the European global satellite-based navigation system, depending on a usage area or bandwidth.

The wired manner may include, for example, at least one of a universal serial bus (USB), a high definition multimedia interface (HDMI), a recommended standard 232 (RS-232), or a plain old telephone service (POTS). A network may include at least one of telecommunications networks, for example, a computer network (e.g., LAN or WAN), the Internet, or a telephone network.

In operation S320, the mobile device 100 may generate the virtual directory information on the files stored in the mobile device 100.

The virtual directory information may be used to display a corresponding virtual directory.

In operation S330, the mobile device 100 may transmit the generated virtual directory information to the external device connected to the mobile device 100.

The virtual directory information may be transmitted to the external device in the predefined manner. After receiving the virtual directory information in the predefined manner, the external device may directly display the virtual directory information without changing environments of the external device such as installing an additional application.

Operations S320 and S330 may be the same as operations S210 and S220 of FIG. 2, respectively.

According to another embodiment, the mobile device 100 may determine whether the external device 200 is permitted to access the files in the mobile device 100. In this case, the mobile device 100 may perform operation S320 or S330 after performing operation S310, only in the case where it is determined that the mobile device 100 is permitted to access the mobile device 100.

According to another embodiment, operation S320 or S330 may be performed immediately after operation S310 regardless of whether the external device 200 is permitted to access the files in the mobile device 100.

According to another embodiment, the mobile device 100 may successively perform operations S320, S310, and S330 to increase access efficiency.

The generating of the virtual directory information on the files stored in the mobile device 100 (operation S320) may be performed when the connection with an external device is established, when a message requesting generation of directory information on the files stored in the mobile device 100 is received from the external device after the connection with the external device is established, when the mobile device 100 performs a confirmation operation that permits access to the external device, when the mobile device 100 is turned on, or when the files stored in the mobile device 100 are modified.

FIG. 4 is a diagram of an example of a process of displaying an actual directory and a virtual directory of a mobile device on an external device according to an embodiment.

A file system 410 of the mobile device 100 may include an internal storage device such as a hard disk or a memory, and an external storage device such as a disk drive or a USB.

According to an embodiment, a file categorizer 430 of the mobile device 100 may generate a virtual directory 440 for all or some files stored in the file system 410 based on the file system 410.

According to an embodiment, the file categorizer 430 may generate a disk structure 420 including all of the internal storage device, the external storage device, and the virtual directory 440.

The mobile device 100 may filter a portion of the generated disk structure 420 by using a disk filter 450. The filtering will be described in detail with reference to FIG. 8.

The mobile device 100 may transmit the disk structure filtered by the disk filter 450 to the external device 200.

As shown in FIG. 4, after the mobile device 100 is connected to the external device 200, the mobile device 100 may enable the actual directory (including the internal storage device and the external storage device) of the mobile device 100 and the virtual directory 460 generated according to an embodiment, to be displayed on the external device 200 through the file management program of the operating system installed in the external device 200 in response to the user's manipulation of activating the mobile device 100 on the external device 200.

Although the mobile device 100 may enable both the actual directory and the virtual directory 460 of the mobile device 100 to be displayed on the external device 200 in the present embodiment, in another embodiment, the mobile device 100 may enable only one of the actual directory and the virtual directory 460 to be displayed on the external device 200.

FIG. 5 is a diagram of an example of generating a virtual directory through a file categorizer according to an embodiment.

The file categorizer 430 of the mobile device 100 may generate the virtual directory 440 for all or some files stored in the file system 410 based on the file system 410 of the mobile device 100.

The file categorizer 430 may scan the files stored in the file system 410 in operation S510.

The file categorizer 430 may group the files scanned in operation S520. The file categorizer 430 may group the scanned files in a predefined manner such that files in the same group are included in the same subdirectory. Here, the grouping may refer to logical grouping that does not modify actual storage paths of the files.

The predefined manner of the grouping may include at least one of a manner of grouping the files based on file directories displayed to the user by the mobile device, a manner of grouping the files based on media types of the files, a manner of grouping the files based on modification dates of the files, a manner of grouping the files based on creation dates of the files, a manner of grouping the files based on applications to which the files belong, a manner of grouping the files based on sources of the files, or a manner of grouping the files based on privacy levels of the files.

The predefined manner of the grouping is not limited thereto and may be any other suitable manner.

In the case of the manner of grouping based on the files based on the file directories displayed to the user by the mobile device 100, the file directory displayed to the user by the mobile device 100 may be substantially the same as or similar to the virtual directory, because the files grouped in the same subdirectory in the file directory displayed to the user by the mobile device 100, that is, the files grouped in the same subdirectory in the file directory may be grouped into the same group in the virtual directory.

In the case of the manner of grouping the files based on the media types of the files, the files of the same media type may be grouped into the same group according to media types of files such as pictures, video, audio, text, and the like.

In the case of the manner of grouping the files based on the modification dates, the files having the same or similar modification dates may be grouped into the same group.

In the case of the manner of grouping the files based on creation dates of the files, the files having the same or similar file creation dates may be grouped into the same group.

In the case of the manner of grouping the files based on the applications to which the files belong, the files that belong to the same application may be grouped into the same group.

In the case of the manner of grouping the files based on the sources of the files, the files of the same or similar sources, such as files downloaded via the same network, may be grouped into the same group.

In the case of the manner of grouping the files based on the privacy levels of the files, the files having the same or similar privacy levels may be grouped into the same group.

The virtual directory may include all or some groups grouped in the predefined manner.

For example, in the case where the predefined manner includes the manner of grouping the files based on the privacy levels of the files, the virtual directory may include only subdirectories corresponding to some groups having a low privacy level.

The file categorizer 430 may store the files grouped in operation S530 in a database and generate the virtual directory 440.

The group files may be updated based on detected updates in operation S540.

FIG. 6 is a flowchart of a method of updating a virtual directory by a mobile device according to an embodiment.

In operation S610, the mobile device 100 may generate the virtual directory information on the files stored in the mobile device 100.

In operation S620, the mobile device 100 may transmit the virtual directory information generated in operation S610 to the external device 200 connected to the mobile device 100.

In operation S630, upon modification of the files stored in the mobile device 100, the mobile device 100 may update the virtual directory information.

The mobile device 100 may determine that the files stored in the mobile device 100 have been modified when a file had been added to the mobile device 100, a file has been deleted from the mobile device 100, a name of a file stored in the mobile device 100 has been changed, or the actual storage path of a file stored in the mobile device 100 had been changed.

For example, the files stored in the mobile device 100 may be modified due to a change in a capacity of the actual storage space, such as due to insertion or removal of an external memory.

According to an embodiment, when the files stored in the mobile device 100 are modified, a message may be transmitted to an MTP layer. Upon initialization of the MTP, a file classifier added to the MTP layer may recognize a file modification message, and the virtual directory information may be updated accordingly.

In operation S640, the mobile device 100 may transmit the updated virtual directory information to the external device 200.

Upon update of the virtual directory information after the generated virtual directory is transmitted to the external device 200, the mobile device 100 may transmit the updated virtual directory information to the external device 200 in the predefined manner.

The external device 200 may receive the updated virtual directory information in the predefined manner, and then directly display the virtual directory included in the updated virtual directory information.

According to an embodiment, in the case where the virtual directory information is updated and then the connection is lost, the mobile device 100 may further include, after operation S620, transmitting the updated virtual directory information to the external device 200 in a predefined manner.

FIG. 7 is a diagram of an example in which an external device accesses files stored in a mobile device through a virtual directory generated according to an embodiment.

FIG. 7 shows a method in which the external device 200 accesses the files stored in the mobile device 100, that is Galaxy C9 Pro, through the virtual directory provided to the external device 200 by the mobile device 100.

In response to the user of the external device 200 selecting the mobile device 100, that is, Galaxy C9 Pro on the external device 200, the external device 200 may display virtual drive letters such as ‘Card’ 710, ‘Library’ 720, and ‘Phone’ 730 that correspond to the mobile device 100.

According to an embodiment, ‘Card’ 710 may correspond to an external storage of the mobile device 100, ‘Library’ 720 may correspond to the virtual directory of the mobile device 100, and ‘Phone’ 730 may correspond to an internal storage.

According to another embodiment, ‘Card’ 710, ‘Library’ 720, and ‘Phone’ 730 may all correspond to the virtual directories of the mobile device 100.

The virtual drive letter may be different from the actual drive letter indicating the actual storage space of the mobile device 100.

The mobile device 100 may display, in response to the user's manipulation of selecting one of the virtual drive letters, a root directory of the selected virtual drive on the external device 200.

For example, in response to the user's manipulation of selecting ‘Library’ 720, the mobile device 100 may display root directories of the selected ‘Library’ 720 on the external device 200.

According to an embodiment, the root directories of ‘Library’ 720 may correspond to groups grouped by the media types and the sources of the files, and may include ‘Application’, ‘Documents’, ‘Movie’, ‘Music’, and ‘Picture’ 740. For example, each object included as the root directories may be set in a form of a folder.

The mobile device 100 may display, in response to the user's manipulation of opening one of the root directories, first level subdirectories corresponding to the selected object in the form of 750 on the external device 200.

For example, when the user double-clicks ‘Picture’ from the root directories of drive ‘Library’ 720, the mobile device 100 may display ‘Camera’, ‘Notification’, and ‘Samsung’ 750 that are the first level subdirectories corresponding to ‘Picture’ on the external device 200.

The mobile device 100 may display, in response to the user's manipulation of opening ‘Camera’ among the first level subdirectories in the external device 200, second level subdirectories corresponding to ‘Camera’ on the external device 200.

The second level subdirectory may include identification information on at least one file in folder ‘Camera’, such as a filename or a thumbnail, that is, identification information of the files of the same group grouped in the predefined manner.

In other words, the identification information of the files of the same type may be displayed under the same folder, and sub-folders grouped corresponding thereto may also be displayed under the same folder.

Furthermore, the mobile device 100 may enable, in response to the user's manipulation on the identification information of a displayed picture, the corresponding picture to be called.

According to an embodiment, the identification information of the file in the virtual directory may be related to the actual storage path of the file, and accordingly, the external device 200 may call, in response to the user's manipulation on the identification information of the file in the virtual directory, the corresponding file.

According to an embodiment, in the case where there is no video file in the mobile device 100, the mobile device 100 may prevent folder ‘Movie’ from being displayed on the external device 200 as the first level subdirectory.

FIG. 8 is a diagram of a user interface through which a user selects a group of the virtual directories according to an embodiment.

According to an embodiment, the virtual directory may not include files of a specific category.

The method of managing files of the mobile device 100 according to an embodiment may include providing a user with a user interface for selecting file categories, and determining categories to be included in the virtual directory based on the file categories selected by the user through the provided user interface.

That is, the virtual directory information for the files stored in the mobile device 100 may be generated based on the file categories selected by the user through the user interface.

The file category may be determined according to at least one of the media type, the modification date, the creation date, the source, the application, the privacy level, or the actual storage path.

According to an embodiment, files that belong to the application selected by the user may be included in the virtual directory.

According to another embodiment, files that do not belong to the application selected by the user may be excluded from the virtual directory.

According to another embodiment, only files having modification dates included in the modification dates selected by the user may be included in the virtual directory.

According to another embodiment, files having modification dates included in the modification dates selected by the user may be removed from the virtual directory.

According to an embodiment, after the mobile device 100 is connected to the external device 200, the mobile device 100 may enable the user interface shown in FIG. 8 to be displayed on the external device 200.

As shown in the embodiment of FIG. 8, in the case where categories ‘Pictures’ and ‘Audios’ are selected according to the user's selection manipulation on the user interface, the virtual directory may be controlled such that only the files in categories ‘Pictures’ and ‘Audios’ are included and the files in the other categories are not included in the virtual directory.

In the case where all of the files of the mobile device 100 need to be displayed in the virtual directory, category ‘All’ may be selected.

FIG. 9 is a flowchart of a method of managing files by a mobile device according to an embodiment.

In operation S910, the mobile device 100 may receive a request for content stored in the mobile device 100 from the external device 200.

In operation S920, the mobile device 100 may generate the virtual directory. Operation S920 may be the same as operation S210 of FIG. 2 or operation S320 of FIG. 3.

In operation S930, the mobile device 100 may map the files stored in the mobile device 100 to the generated virtual directory.

In operation S940, the mobile device 100 may filter the virtual directory. According to an embodiment, the filtering of the virtual directory may be performed based on a user input into the user interface of FIG. 8. According to another embodiment, the filtering of the virtual directory may be automatically performed according to a predefined filtering criterion.

Although the filtering is performed after the virtual directory is generated (S920) in the present embodiment, according to another embodiment, the virtual directory may be generated only for the received categories after receiving the user's category selection through the user interface of FIG. 8.

That is, the selecting of the file categories to be included in the virtual directory may be performed prior to the generating of the virtual directory.

In operation S950, the mobile device 100 may transmit the filtered virtual directory to the external device 200. Operation S950 may be the same as operation S220 of FIG. 2 or operation S330 of FIG. 3.

The method in the disclosure may be executed by a processor, an application specific integrated circuit (ASIC), a field programmable gate array (FPGA), or a system-on-chip (SoC). In addition, the described method may be executed by a storage medium that stores computer-executable instructions and enables the method of the disclosure to be executed when the instructions are executed by a processor.

The machine-readable storage medium may be provided in a form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the non-transitory storage medium may include a buffer in which data is temporarily stored.

A method according to various embodiments disclosed herein may be included in a computer program product and provided. The computer program product may be traded between a seller and a purchaser as a commodity. The computer program product may be distributed in a form of a machine-readable storage medium (e.g., compact disk read only memory (CD-ROM)), or may be distributed online (e.g., downloaded or uploaded) through an application store (e.g., Google Play™) or directly between two user devices (e.g., smart phones). In the case of online distribution, at least a portion of the computer program product (e.g., a downloadable app) may be temporarily stored in a machine-readable storage medium such as a manufacturer's server, an application store's server, or a memory of a relay server.

The above-described description of the disclosure is provided only for illustrative purposes, and those of skill in the art will understand that the disclosure may be easily modified into other detailed configurations without modifying technical aspects and essential features of the disclosure. Therefore, it should be understood that the above-described embodiments should be considered in a descriptive sense only and not for purposes of limitation. For example, the elements described as single entities may be executed in a distributed fashion, and similarly, the elements that are distributed may be combined and then executed.

The scope of the disclosure is defined by the claims below rather than the above detailed description, and should be construed that all modifications or modified forms derived from the meaning and scope of the claims and their equivalents are included in the scope of the disclosure.

What is claimed is:

1. A method of managing files by a mobile device, the method comprising:
generating virtual directory information corresponding to files stored in the mobile device; and
transmitting, to an external device, the generated virtual directory information to cause the external device to display a virtual directory included in the virtual directory information and through which the files stored in the mobile device are accessible through the displayed virtual directory.

2. The method of claim 1, wherein the virtual directory is generated by grouping the files stored in the mobile device in a predefined manner such that files of a same group are in a same subdirectory.

3. The method of claim 2, wherein the predefined manner is different from a manner of grouping the files based on storage paths of the files in a storage space of the mobile device, and does not modify the storage paths of the files in the storage space of the mobile device.

4. The method of claim 1, wherein the virtual directory information includes virtual drive letter information,
wherein the transmitting, to the external device, the generated virtual directory information causes the external device to display a virtual drive letter and the virtual directory under the virtual drive letter, and
wherein the virtual drive letter is different from an actual drive letter indicating a storage space of the mobile device.

5. The method of claim 2, wherein the predefined manner includes at least one of a manner of grouping the files based on file directories displayed to a user by the mobile device, a manner of grouping the files based on media types of the files, a manner of grouping the files based on modification dates of the files, a manner of grouping the files based on creation dates of the files, a manner of grouping the files based on applications to which the files belong, a manner of grouping the files based on sources of the files, or a manner of grouping the files based on privacy levels of the files.

6. The method of claim 1, further comprising providing a user interface configured to receive a selection of at least one file category to be included in the virtual directory,
wherein the virtual directory information is generated based on the at least one file category selected through the user interface.

7. The method of claim 1, further comprising:
updating the virtual directory information based on modification of the files stored in the mobile device; and
transmitting, based on the virtual directory information being updated after the virtual directory information is transmitted to the external device, the updated virtual directory information to the external device.

8. The method of claim 1, further comprising transmitting a directory of a storage space of the mobile device to the external device such that the external device displays the virtual directory and the directory of the storage space of the mobile device.

9. The method of claim 1, wherein the mobile device transmits the virtual directory information to the external device using a predefined software protocol for media file transfer.

10. A mobile device comprising:
a memory configured to store at least one instruction; and
a processor configured to execute the at least one instruction to generate virtual directory information corresponding to files stored in the mobile device, and transmit, to an external device, the generated virtual directory information to cause the external device to display a virtual directory included in the virtual directory information and through which the files stored in the mobile device are accessible through the displayed virtual directory.

11. The mobile device of claim 10, wherein the virtual directory is generated by grouping the files stored in the mobile device in a predefined manner such that files of a same group are included in a same subdirectory.

12. The mobile device of claim 11, wherein the predefined manner is different from a manner of grouping the files based on storage paths of the files in a storage space of the mobile device, and does not modify the storage paths of the files in the storage space of the mobile device.

13. The mobile device of claim 10, wherein the virtual directory information includes virtual drive letter information,
wherein the processor is further configured to execute the at least one instruction to transmit, to the external device, the generated virtual directory information to cause a virtual drive letter to be displayed on the external device and the virtual directory to be displayed under the virtual drive letter, and
wherein the virtual drive letter is different from an actual drive letter indicating a storage space of the mobile device.

14. The mobile device of claim 11, wherein the predefined manner includes at least one of a manner of grouping the files based on file directories displayed to a user by the mobile device, a manner of grouping the files based on media types of the files, a manner of grouping the files based on modification dates of the files, a manner of grouping the files based on creation dates of the files, a manner of grouping the files based on applications to which the files belong, a manner of grouping the files based on sources of the files, or a manner of grouping the files based on privacy levels of the files.

15. The mobile device of claim 10, wherein the processor is further configured to execute the at least one instruction to provide a user with a user interface configured to receive a selection of at least one file category to be included in the virtual directory, and
wherein the virtual directory information is generated based on the at least one file category selected through the user interface.

16. The mobile device of claim 10, wherein the processor is further configured to execute the at least one instruction to:
update the virtual directory information based on modification of the files stored in the mobile device, and
transmit, based on the virtual directory information being updated after the virtual directory information is transmitted to the external device, the updated virtual directory information to the external device.

17. The mobile device of claim 10, wherein the processor is further configured to execute the at least one instruction to transmit a directory of a storage space of the mobile device to the external device such that the external device displays the virtual directory and the directory of the storage space of the mobile device.

18. The mobile device of claim 10, wherein the virtual directory information is transmitted to the external device using a predefined software protocol for media file transfer.

19. A non-transitory computer-readable recording medium having recorded thereon a program which is executed by a processor to perform the method of claim 1.
